(19) United States
(12) Patent Application Publication
(10) Pub. No.: US 2023/0055856 A1
(43) Pub. Date: Feb. 23, 2023

(54) ELECTROPHOTOGRAPHIC PHOTOSENSITIVE MEMBER, PROCESS CARTRIDGE, AND ELECTROPHOTOGRAPHIC APPARATUS

(71) Applicant: CANON KABUSHIKI KAISHA, Tokyo (JP)

(72) Inventors: Michiyo Sekiya, Shizuoka (JP); Kaname Watariguchi, Kanagawa (JP); Kenichi Kaku, Shizuoka (JP)

(21) Appl. No.: 17/812,227

(22) Filed: Jul. 13, 2022

(30) Foreign Application Priority Data
Aug. 6, 2021 (JP) 2021-130210

(51) Int. Cl. G03G 5/047; G03G 5/06; G03G 15/00

(52) U.S. Cl. CPC G03G 5/047; G03G 5/0696; G03G 15/75

(57) ABSTRACT

An electrophotographic photosensitive member has a charge generation layer having a film thickness of 0.2 μm or larger and a charge transport layer on a support, wherein in a case where, at 23.5° C. and 50% RH, the photosensitive member is subjected to operations and measurement of: specific (1), (2), (3) and (4), an absolute value of a slope α of a linear approximation straight line is 4×10⁻³ or smaller, in a range where the electric field strength E is 10 to 40 V/μm, which is expressed by a relational expression between a recombination constant Pₑ and an electric field strength E, which is obtained from a specific graph which has been obtained by repeatedly performing the specific operations and measurement of (1) to (4) while changing Iₑₓₚ from 0.000 to 1.000 μJ/cm² at intervals of 0.001 μJ/cm².

### BACKGROUND OF THE INVENTION

### Field of the Invention

The present disclosure relates to an electrophotographic photosensitive member, and a process cartridge and an electrophotographic apparatus each having the electrophotographic photosensitive member.

### Description of the Related Art

The electrophotographic photosensitive member that is used in electrophotographic apparatuses such as copying machines and laser beam printers is required to have sufficient sensitivity to light for image exposure. Azo pigments and phthalocyanine pigments which are used as charge transport materials are known to exhibit high sensitivity to light in a wide range of wavelengths. In addition to the above situation, in recent years, a high image quality is required as represented by colorization, and because of the colorization, halftone images and solid images represented by photographs have increased, and the image quality thereof has been enhancing year by year.

In order to enhance the image quality, as a function desired for the electrophotographic photosensitive member, it is required to maintain a high contrast over the time from the initial stage to the endurance life.

In the electrophotographic photosensitive member, it is desired to design the film thickness of the charge generation layer so as to be thick from the viewpoint of the high sensitivity, but in this case, the obtained electrophotographic photosensitive member has a defect that the memory occurs. In addition, it is better also for the charge transport layer to have the film thickness designed to be thicker, from the viewpoint of the higher sensitivity, but in this case, the obtained electrophotographic photosensitive member has a defect that a residual charge results in increasing, and the above memory also tends to deteriorate.

On the other hand, in order to reduce the environmental load, energy saving is desired, and it is conceivable from the viewpoint to lower the voltage applied to a charging device in the electrophotographic apparatus, but when the voltage to be applied is lowered, an electric field strength becomes small which is applied to the electrophotographic photosensitive member, and accordingly, the memory originating in the above charge generation layer further deteriorates.

In Japanese Patent Application Laid-Open No. H10-115939, an electrophotographic photosensitive member is described that is excellent in durability and sensitivity, by having a combination of a charge generation layer and a charge transfer layer, in which η has a sufficiently weak level of electric field dependency, in a relationship between the quantum efficiency η and the electric field E as the electrophotographic photosensitive member, and having a specific film thickness of the charge transfer layer.

In Japanese Patent Application Laid-Open No. 2005-091882, an electrophotographic apparatus is described in which a surface potential on an image carrying body is measured at the time of being exposed to light while the exposure energy is varied, and the image carrying body is irradiated with exposure energy J at which the surface potential becomes 1.3 times or higher than a theoretical value based on the light attenuation characteristics of the image carrying body. This electrophotographic apparatus controls a recombination ratio, specifically, increases the amount of electric charges (carriers) generated in the image carrying body and increases the recombination of the carriers; and thereby controls the reduction of a latent image potential, regulates the amount of toner on the image carrying body, and thereby can form an image having a high image quality and an excellent gradation property.

Japanese Patent Application Laid-Open No. 2018-189957, has found that regarding an increase in dark decay which occurs when a charge generation layer using a phthalocyanine pigment is formed as a thick film, there is a correlation between the degree of alignment in a π-stack direction and a molecular axis direction of the phthalocyanine pigment, specifically, a ratio between the crystal correlation lengths, and the dark decay. A parameter obtained from an X-ray diffraction spectrum is used for the ratio between the crystal correlation lengths, and it is described that the dark decay is suppressed by setting the ratio to a specific value.

### SUMMARY OF THE INVENTION

According to the study by the present inventors, in the electrophotographic photosensitive member described in Japanese Patent Application Laid-Open No. H10-115939, the electric field dependency has been small in the relation between the quantum efficiency η and the electric field E, and the sensitivity has been satisfactory, but the memory has occurred. The result has been caused by the fact that the film thickness of the charge generation layer of the configuration disclosed in the Examples has been 0.4 μm, and electric charges has accumulated in the charge generation layer. Furthermore, the film thickness of the charge transport layer has been 25 μm or larger, and thereby, the memory phenomenon has appeared more remarkably, because as the film thickness of the charge transport layer increases, the electric field strength decreases.

In Japanese Patent Application Laid-Open No. 2005-091882, it is disclosed that the decrease in the latent image potential can be suppressed by increasing the amount of electric charges (carriers) generated in the image carrying body and increasing the recombination of the carriers, and the amount of the toner consumption can be reduced. However, when an attention has been focused on the memory phenomenon, there has been a problem that the generation and recombination of the carriers are repeated by performing endurance in a state in which the recombination of the carriers is increased, as a result, a ratio of electric charges accumulating in the charge generation layer increases, and the memory phenomenon gives an endurance history and thereby increases.

In Japanese Patent Application Laid-Open No. 2018-189957, it is disclosed that even when the film thickness of the charge generation layer is made larger than 200 nm, the dark decay is suppressed by use of a phthalocyanine pigment exhibiting specific characteristics. However, in a situation where the electric field strength is particularly low, electric charges are generated which accumulate in the charge generation layer, and accordingly, the memory phenomenon cannot have been sufficiently reduced.

Accordingly, an object of the present disclosure is to provide an electrophotographic photosensitive member which does not generate the memory and maintains a high contrast throughout endurance.

Furthermore, another object of the present disclosure is to provide a process cartridge and an electrophotographic apparatus each having the electrophotographic photosensitive member that does not generate the memory and maintains the high contrast throughout the endurance.

The above object is achieved by the following present disclosure.

Specifically, an electrophotographic photosensitive member according to the present disclosure is an electrophotographic photosensitive member including a support, a charge generation layer on the support, and a charge transport layer on the charge generation layer, the charge generation layer having a film thickness of 0.2 μm or larger, wherein in a case where, at a temperature of 23.5 [° C.] and a relative humidity of 50 [% RH], the electrophotographic photosensitive member is subjected to operations and measurement of: (1) setting a surface potential of the electrophotographic photosensitive member to 0 [V]; (2) electrostatically charging the electrophotographic photosensitive member for 0.005 seconds so that an absolute value of the surface potential of the electrophotographic photosensitive member becomes Vd [V]; (3) 0.02 seconds after a start of electrostatic charging, exposing the electrostatically charged electrophotographic photosensitive member to light having a wave length of 805 [nm] and a light quantity of Iₑₓₚ[μJ/cm²]; and (4) 0.06 seconds after the start of the electrostatic charging, measuring the absolute value of the surface potential of the electrophotographic photosensitive member after exposure, the absolute value being represented by Vₑₓₚ[V], in a relationship between a recombination constant Pₑ and an electric field strength E, which is obtained from a graph in which a horizontal axis represents a light quantity Iₑₓₚ of exposure light and a vertical axis represents the absolute value Vₑₓₚ of the surface potential, which has been obtained by repeatedly performing the operations and the measurement of (1) to (4) while changing Iₑₓₚ from 0.000 to 1.000 [μJ/cm²] at intervals of 0.001 [μJ/cm²], an absolute value of a slope a of a linear approximation straight line is 4×10⁻³ or smaller, in a range where the electric field strength E expressed by the following Expression (1) is 10 to 40 V/μm:

Pₑ=α×E+γ (1)

where, in the Expression (1) and the following Expression (2), Pₑ and Vᵣ represent a recombination constant and a residual charge, respectively, which are obtained from the following Expression (2), where a quantum efficiency is represented by η₀, which is obtained with the use of the following Expression (3) from data points in the graph in a range until Vₑₓₚ of the graph decreases to Vd/2; and E represents the electric field strength V/μm obtained from the Vd and the film thickness of the charge transport layer:

$$\frac{{V}_{exp} - {V}_{r}}{{V}_{d} - {V}_{r}} = {[ 1 - ( 1 - {P}_{e} ) \frac{e d {η}_{0} {I}_{exp}}{{ε}_{0} {ε}_{r} h v ( {V}_{d} - {V}_{r} )} ]}^{1 / ( 1 - {P}_{e} )} \qquad ( 2 )$$

$$\frac{{V}_{exp}}{{V}_{d}} = {[ 1 - 0.4 \frac{e d {η}_{0} {I}_{exp}}{{ε}_{0} {ε}_{r} h v {V}_{d}} ]}^{2.5} \qquad ( 3 )$$

where, in the Expressions (2) and (3), e represents an elementary charge, d represents a film thickness of the photosensitive layer, η₀ represents a quantum efficiency, ε₀ represents a dielectric constant of vacuum, εᵣ represents a relative dielectric constant, h represents a Planck constant, and v represents a frequency of irradiation light.

According to the present disclosure, an electrophotographic photosensitive member can be provided which does not generate the memory and can maintain a high contrast throughout endurance.

Further features of the present disclosure will become apparent from the following description of exemplary embodiments with reference to the attached drawings.

### BRIEF DESCRIPTION OF THE DRAWINGS

FIG. 1 illustrates a view illustrating one example of a schematic configuration of an electrophotographic apparatus provided with a process cartridge that includes an electrophotographic photosensitive member of the present disclosure.

FIG. 2 illustrates a powder X-ray diffraction pattern of a hydroxygallium phthalocyanine crystal.

FIG. 3 illustrates one example of a graph that is created by repeating operations and measurement while changing the Iₑₓₚ at intervals of 0.001 [μJ/cm²] from 0.000 to 1.000 [μJ/cm²], and in which the horizontal axis is Iₑₓₚ and the vertical axis is Vₑₓₚ.

FIG. 4 illustrates one example of a graph illustrating a slope α of a linear approximation straight line at an electric field strength of 10 to 40 V/μm, with the obtained recombination constant Pₑ on a vertical axis and the electric field strength E on a horizontal axis.

FIG. 5A illustrates a diagram for describing an image for ghost evaluation, which is used at the time of the evaluation of a ghost image.

FIG. 5B illustrates a diagram for describing an image of a 1-dot knight pattern.

### DESCRIPTION OF THE EMBODIMENTS

Preferred embodiments of the present disclosure will now be described in detail in accordance with the accompanying drawings.

The above object is achieved by the following present disclosure. Specifically, the present disclosure provides an electrophotographic photosensitive member including a support, a charge generation layer on the support, and a charge transport layer on the charge generation layer, the charge generation layer having a film thickness of 0.2 μm or larger, wherein

in a case where, at a temperature of 23.5 [° C.] and a relative humidity of 50 [% RH], the electrophotographic photosensitive member is subjected to operations and measurement of:

(1) setting a surface potential of the electrophotographic photosensitive member to 0 [V];

(2) electrostatically charging the electrophotographic photosensitive member for 0.005 seconds so that an absolute value of the surface potential of the electrophotographic photosensitive member becomes Vd [V];

(3) 0.02 seconds after a start of electrostatic charging, exposing the electrostatically charged electrophotographic photosensitive member to light having a wave length of 805 [nm] and a light quantity of Iₑₓₚ [μJ/cm²]; and

(4) 0.06 seconds after the start of the electrostatic charging, measuring the absolute value of the surface potential of the electrophotographic photosensitive member after exposure, the absolute value being represented by Vₑₓₚ [V],

in a relationship between a recombination constant Pₑ and an electric field strength E, which is obtained from a graph in which a horizontal axis represents a light quantity Iₑₓₚ of exposure light and a vertical axis represents the absolute value Vₑₓₚ of the surface potential, which has been obtained by repeatedly performing the operations and the measurement of (1) to (4) while changing Iₑₓₚ from 0.000 to 1.000 [μJ/cm²] at intervals of 0.001 [μJ/cm²], an absolute value of a slope a of a linear approximation straight line is 4×10⁻³ or smaller, in a range where the electric field strength E expressed by the following Expression (1) is 10 to 40 V/μm:

Pₑ=α×E+γ (1)

where, in the Expression (1) and the following Expression (2), Pₑ and Vᵣ represent a recombination constant and a residual charge, respectively, which are obtained from the following Expression (2), where a quantum efficiency is represented by η₀, which is obtained from a slope in a range until Vd of the graph decreases to Vd/2; and E represents the electric field strength V/μm obtained from the Vd and the film thickness of the charge transport layer:

$$\frac{{V}_{exp} - {V}_{r}}{{V}_{d} - {V}_{r}} = {[ 1 - ( 1 - {P}_{e} ) \frac{e d {η}_{0} {I}_{exp}}{{ε}_{0} {ε}_{r} h v ( {V}_{d} - {V}_{r} )} ]}^{1 / ( 1 - {P}_{e} )} \qquad ( 2 )$$

where, in the Expression (2), e represents an elementary charge, d represents a film thickness of the photosensitive layer, co represents a dielectric constant of vacuum, εᵣ represents a relative dielectric constant, h represents a Planck constant, and v represents a frequency of irradiation light.

A method of obtaining the slope α for deriving Expression (1) and a procedure of obtaining Vᵣ (residual charge), η₀ (quantum efficiency), and Pₑ (recombination constant) from Expression (2) are as follows.

Procedure 1: Arbitrary Vd is set at several points between the electric field strengths of 10 to 40 V (Vd=electric field strength E x film thickness of photosensitive member). A graph is created that is obtained by repeating Iₑₓₚ at the set Vd while changing the Iₑₓₚ from 0.000 to 1.000 [μJ/cm²] at intervals of 0.001 [μJ/cm²], and in which the horizontal axis represents the light quantity Iₑₓₚ of the exposure light and the vertical axis represents the absolute value Vₑₓₚ of the surface potential.

FIG. 3 illustrates one example of a graph that is obtained by repeating the Iₑₓₚ at the time when Vd is 500 V while changing the Iₑₓₚ at intervals of 0.001 [μJ/cm²] from 0.000 to 1.000 [μJ/cm²], and in which the horizontal axis is the light quantity Iₑₓₚ of the exposure light and the vertical axis is the absolute value Vₑₓₚ of the surface potential.

Procedure 2: The quantum efficiency η₀ in Expression (2) is obtained by fitting data points of the Iₑₓₚ−Vₑₓₚ graph in a range until Vₑₓₚ decreases to Vd/2, with the use of the following Expression (3) while using η₀ as a fitting parameter.

$$\frac{{V}_{exp}}{{V}_{d}} = {[ 1 - 0.4 \frac{e d {η}_{0} {I}_{exp}}{{ε}_{0} {ε}_{r} h v {V}_{d}} ]}^{2.5} \qquad ( 3 )$$

Procedure 3: Data points of the Iₑₓₚ−Vₑₓₚ graph in a range of measured all light quantities, in other words, in the range of Iₑₓₚ=0.000 to 1.000 [μJ/cm²] are subjected to fitting with the use of Expression (2), while fixing the value of η₀ obtained in the procedure 2 and using Pₑ and Vᵣ as fitting parameters to determine the recombination constant Pₑ and the residual charge Vᵣ.

Procedure 4: Procedures 1 to 3 are repeated while changing Vd, and the electric field strength is changed between 10 and 40 V; and thereby the quantum efficiencies η₀, the recombination constants Pₑ, and the residual charges Vᵣ are determined at the time. From the obtained values, the slope α of the linear approximation straight line at the electric field strengths of 10 to 40 V/μm is obtained, which are expressed by Expression (1).

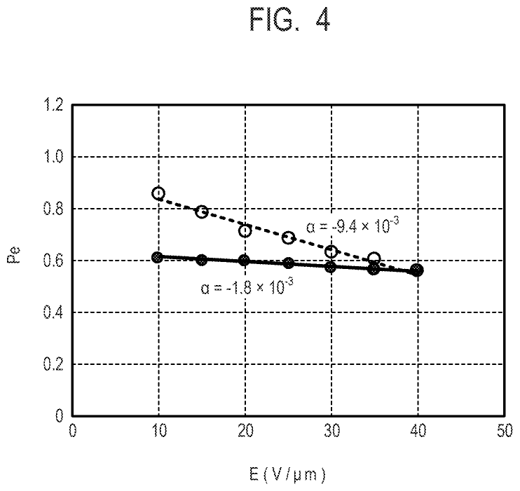

FIG. 4 illustrates one example of a graph illustrating the slope a of the linear approximation straight line at the electric field strengths of 10 to 40 V/μm, with the obtained recombination constant Pₑ on a vertical axis and the electric field strength E on a horizontal axis.

When the film thickness of the charge generation layer increases, the memory phenomenon results in occurring, and gives the endurance history; and thereby, a further increase of the memory occurs. As a result of the study, the memory phenomenon remarkably occurred by increasing the film thickness of the charge generation layer and decreasing the electric field strength. It can be assumed that an electric charge accumulated in the charge generation layer is the cause of the memory phenomenon.

It is ideal that even if the film thickness of the charge generation layer is large, charge separation is rapidly performed after exposure, positive and negative charges are smoothly injected into the charge transport layer and the undercoat layer, and thereby such an E-V curve characteristic is obtained that the recombination ratio is low and the residual charge is also low.

The present inventors have considered that the amount of accumulated charges in the charge generation layer has a strong correlation with the recombination ratio, and have focused on the recombination constant which is expressed by Expression (2).

However, it is not necessarily the case that when the recombination constant is low, the occurrence of the memory phenomenon is suppressed, and it has been necessary that a representing the electric field dependency is 4×10⁻³ or smaller.

The reason why the memory phenomenon becomes small when the electric field dependency α is 4×10⁻³ or smaller is presumed in the following way.

The accumulated charges which cause the memory are electric charges which are accumulated in the charge generation layer without being recombined, and whether the electric charges are injected, recombined or accumulated is determined by a magnitude of a driving force which depends on the magnitude of the electric field.

Accordingly, the fact that the electric field dependency of the recombination constant Pₑ is small means that an electric charge to be injected in a case where the electric field is increased does not increase, and even if the endurance history is given, a rate of the change is small. Accordingly, a correlation is found between the electric field dependency of the recombination constant Pₑ and the memory phenomenon.

In addition, the effect of the present disclosure is further exhibited in a low electric field.

It is more preferable that an absolute value of the electric field dependency α is 2×10⁻³ or smaller. When the value is larger than 2×10⁻³, there has been a case where a rate of change does not become sufficiently small when the endurance history has been given.

It is more preferable that the recombination constant Pₑ expressed by Expression (2) at an electric field strength of 15 V/μm is 0.7 or smaller. When the constant is larger than 0.7, there has been a case where the effect of reducing the initial memory is not sufficiently obtained in the low electric field.

It is more preferable that the quantum efficiency η₀ expressed by Expression (2) at an electric field strength of 15 V/μm is 0.4 or larger. When the constant is smaller than 0.4, there has been a case where the effect of reducing the initial memory is not sufficiently obtained in the low electric field.

It is more preferable that the residual charge Vᵣ expressed by Expression (2) at the electric field strength of 15 V/μm is 20 V or smaller. When the residual charge is larger than 20 V, there has been a case where the effect of reducing the initial memory is not sufficiently obtained in the low electric field.

For information, in the present disclosure, the memory phenomenon originating in the amount of accumulated charges in the charge generation layer can be evaluated as a ghost phenomenon (a phenomenon in which a density of only a portion irradiated with light appears differently, in a case where a portion irradiated with light becomes a halftone image in the next rotation of the electrophotographic photosensitive member, while one sheet of an image is formed).

### Electrophotographic Photosensitive Member

The electrophotographic photosensitive member of the present disclosure includes a charge generation layer and a charge transport layer.

Examples of a method for producing the electrophotographic photosensitive member of the present disclosure include a method for preparing a coating liquid for each layer, which will be described later, applying the coating liquids in order of desired layers, and drying the coating liquids. Examples of a method for applying the coating liquid at this time include, dip coating, spray coating, inkjet coating, roll coating, die coating, blade coating, curtain coating, wire bar coating and ring coating. Among the coating methods, the dip coating is preferable from the viewpoint of efficiency and productivity.

The support and each layer will be described below.

### Support

In the present disclosure, the electrophotographic photosensitive member has a support. It is preferable for the support to be an electroconductive material (electroconductive support). In addition, shapes of the support include a cylindrical shape, a belt shape and a sheet shape. Among the supports, the cylindrical support is preferable. In addition, the surface of the support may be subjected to electrochemical treatment such as anodization, blast treatment, cutting treatment and the like.

As a material of the support, a metal, a resin, glass and the like are preferable.

Examples of the metal include aluminum, iron, nickel, copper, gold, stainless steel, and alloys thereof. Among the metals, an aluminum support using aluminum is preferable.

In addition, the electroconductivity may be imparted to the resin or the glass by treatment such as mixing of or coating with an electroconductive material.

### Electroconductive Layer

In the present disclosure, an electroconductive layer may be provided on the support. By the electroconductive layer being provided, the support can conceal scratches and unevenness on its surface and can control the reflection of light on its surface.

It is preferable that the electroconductive layer contains an electroconductive particle and a resin.

Examples of a material of the electroconductive particle include a metal oxide, a metal, and carbon black.

Examples of the metal oxide include zinc oxide, aluminum oxide, indium oxide, silicon oxide, zirconium oxide, tin oxide, titanium oxide, magnesium oxide, antimony oxide and bismuth oxide. Examples of the metal include aluminum, nickel, iron, nichrome, copper, zinc and silver.

Among these substances, it is preferable to use metal oxides as the electroconductive particle, and is more preferable to use, in particular, titanium oxide, tin oxide and zinc oxide.

When a metal oxide is used as the electroconductive particle, the surface of the metal oxide may be treated with a silane coupling agent or the like, or the metal oxide may be doped with an element such as phosphorus or aluminum, or an oxide thereof.

In addition, the electroconductive particle may have a layered structure having a core material particle and a covering layer which covers the particle. Examples of the core material particle include titanium oxide, barium sulfate and zinc oxide. Examples of the covering layer include a metal oxide such as tin oxide.

In addition, when a metal oxide is used as the electroconductive particle, it is preferable for a volume-average particle size thereof to be 1 to 500 nm, and is more preferable to be 3 to 400 nm.

Examples of the resin include a polyester resin, a polycarbonate resin, a polyvinyl acetal resin, an acrylic resin, a silicone resin, an epoxy resin, a melamine resin, a polyurethane resin, a phenol resin and an alkyd resin.

In addition, the electroconductive layer may further contain a concealing agent such as a silicone oil, a resin particle and titanium oxide.

It is preferable for an average film thickness of the electroconductive layer to be 1 to 50 μm, and is particularly preferable to be 3 to 40 μm.

The electroconductive layer can be formed by preparing a coating liquid for the electroconductive layer, which contains each of the above described materials and a solvent, forming a coating film of the coating liquid on the support, and drying the coating film. Examples of the solvent to be used for the coating liquid include an alcohol-based solvent, a sulfoxide-based solvent, a ketone-based solvent, an ether-based solvent, an ester-based solvent and an aromatic hydrocarbon-based solvent. Examples of a dispersion method for dispersing the electroconductive particles in the coating liquid for the electroconductive layer include methods which use a paint shaker, a sand mill, a ball mill, and a liquid collision type high-speed dispersion machine.

### Undercoat Layer

In the present disclosure, an undercoat layer may be provided on the support or the electroconductive layer. The undercoat layer which has been provided can thereby enhance an adhesion function between layers and impart a charge injection inhibition function.

It is preferable that the undercoat layer contains a resin. In addition, the undercoat layer may be formed as a cured film by polymerization of a composition which contains a monomer having a polymerizable functional group.

Examples of the resin include a polyester resin, a polycarbonate resin, a polyvinyl acetal resin, an acrylic resin, an epoxy resin, a melamine resin, a polyurethane resin, a phenol resin, a polyvinyl phenol resin, an alkyd resin, a polyvinyl alcohol resin, a polyethylene oxide resin, a polypropylene oxide resin, a polyamide resin, a polyamic acid resin, a polyimide resin, a polyamide imide resin and a cellulose resin.

Examples of the polymerizable functional group which the monomer having the polymerizable functional group has include an isocyanate group, a blocked isocyanate group, a methylol group, an alkylated methylol group, an epoxy group, a metal alkoxide group, a hydroxyl group, an amino group, a carboxyl group, a thiol group, a carboxylic acid anhydride group and a carbon-carbon double bond group.

Among the resins, the polyamide resin is preferable, and a polyamide resin soluble in an alcohol-based solvent is preferable. For example, a ternary (6-66-610) copolymer polyamide, a quaternary (6-66-610-12) copolymer polyamide, N-methoxymethylated nylon, polymerized fatty acid-based polyamide, polymerized fatty acid-based polyamide block copolymer, copolymerized polyamide having a diamine component and the like are preferably used.

In addition, the undercoat layer may further contain an electron transport material, a metal oxide, a metal, an electroconductive polymer and the like, for the purpose of enhancing the electric characteristics. Among the materials, it is preferable to use the electron transport material and the metal oxide, because an effect of extracting electric charges in the charge generation layer can be obtained even in a low electric field.

Examples of the electron transport material include a quinone compound, an imide compound, a benzimidazole compound, a cyclopentadienylidene compound, a fluorenone compound, a xanthone compound, a benzophenone compound, a cyanovinyl compound, a halogenated aryl compound, a silole compound and a boron-containing compound. The undercoat layer may also be formed as a cured film, by using an electron transport material having a polymerizable functional group, as the electron transport material, and copolymerizing the electron transport material with a monomer having the above described polymerizable functional group.

Examples of the metal oxide include indium tin oxide, tin oxide, indium oxide, titanium oxide, zinc oxide, aluminum oxide and silicon dioxide. Examples of the metal include gold, silver and aluminum.

Among the substances, the titanium oxide is preferable, and it is preferable for the crystal structure to be a rutile type or an anatase type, and is more preferable to be the rutile type of which the photocatalytic activity is weak, from the viewpoint of suppressing the accumulation of electric charges. When the crystal structure is the rutile type, it is preferable that a rutilated ratio is 90% or larger. It is preferable that the shape of the titanium oxide particle is spherical; and an average primary particle size thereof is preferably 10 to 100 nm, and is more preferably 30 to 60 nm, from the viewpoints of the suppression of the accumulation of the electric charge and uniform dispersibility. The titanium oxide particle may be treated with a silane coupling agent or the like, from the viewpoint of the uniform dispersibility.

It is preferable that the titanium oxide particle is surface-treated with vinylsilane, because an effect of extracting electric charges in the charge generation layer can be obtained even in a low electric field.

In addition, the undercoat layer may also further contain an additive.

It is preferable for an average film thickness of the undercoat layer to be 0.1 to 10 μm, is more preferable to be 0.2 to 5 μm, and is particularly preferable to be 0.3 to 3 μm.

The undercoat layer can be formed by preparing a coating liquid for the undercoat layer which contains each of the above described materials and a solvent, forming a coating film of the coating liquid on the support or the electroconductive layer, and drying and/or curing the coating film. Examples of the solvent to be used for the coating liquid include an alcohol-based solvent, a ketone-based solvent, an ether-based solvent, an ester-based solvent and an aromatic hydrocarbon-based solvent.

### Charge Generation Layer

It is preferable that the charge generation layer contains a charge generation material and a resin.

Examples of the charge generation material include an azo pigment, a perylene pigment, a polycyclic quinone pigment, an indigo pigment and a phthalocyanine pigment. Among the pigments, the phthalocyanine pigment is preferable. Among the phthalocyanine pigments, hydroxygallium phthalocyanine pigments are preferable.

Among the hydroxygallium phthalocyanine pigments, a hydroxygallium phthalocyanine pigment is preferable which has a crystal particle having a crystal form that exhibits peaks at 7.4°±0.3° and 28.2°±0.3° at Bragg angle 2θ in a spectrum of X-ray diffraction using a CuKαray. FIG. 2 illustrates an example of the spectrum of X-ray diffraction of the hydroxygallium phthalocyanine pigment.

In particular, in order to achieve high sensitivity with a thick film and to reduce accumulated charges in the charge generation layer under a low electric field, it is preferable to use a hydroxygallium phthalocyanine pigment in which A is 0.8 or less, which is determined from an angle θ1 [° ] and an integral width β₁ [° ] of the peak at 7.4°±0.3°, and an angle θ₂ [° ] and an integral width β₂ [° ] of the peak at 28.2°±0.3°, and according to the following formula (4).

$$A = \frac{{β}_{1} cos {θ}_{1}}{{β}_{2} cos {θ}_{2}} \qquad ( 4 )$$

It is assumed that when A is 0.8 or smaller, the electric charge accumulated in the crystal particle of the hydroxygallium phthalocyanine pigment is reduced and the effect of the present application tends to be easily obtained.

Furthermore, it is more preferable that the hydroxygallium phthalocyanine pigment has a crystal particle which contains an amide compound represented by the following Formula (A1) in the particle. Examples of the amide compound represented by Formula (A1) include N-methylformamide, N-propylformamide and N-vinylformamide.

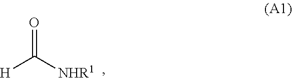

wherein R¹ represents a methyl group, a propyl group or a vinyl group.

In addition, a content of the amide compound represented by Formula (A1), which is contained in the crystal particle, is preferably 0.1 to 3.0% by mass, and is more preferably 0.1 to 1.4% by mass, with respect to the content of the crystal particles. Due to the content of the amide compound being 0.1 to 3.0% by mass, the size of the crystal particles can be aligned in an appropriate size. The phthalocyanine pigment containing the amide compound represented by Formula (A1) in the crystal particle can be obtained by a process of converting the crystals by subjecting a phthalocyanine pigment obtained by an acid-pasting method and the amide compound represented by the above Formula (A1), to wet milling treatment.

When a dispersing agent is used in the milling treatment, the amount of the dispersing agent is preferably 10 to 50 times the amount of the phthalocyanine pigment on a mass basis. In addition, examples of solvents to be used include: amide-based solvents such as N,N-dimethylformamide, N,N-dimethylacetamide, compounds represented by the above Formula (A1), N-methylacetamide and N-methylpropionamide; halogen-based solvents such as chloroform; ether-based solvents such as tetrahydrofuran; and sulfoxide-based solvents such as dimethylsulfoxide. In addition, the amount of the solvent to be used is preferably 5 to 30 times the amount of the phthalocyanine pigment on a mass basis.

The phthalocyanine pigment contained in the electrophotographic photosensitive member of the present disclosure has been subjected to powder X-ray diffraction measurement employing the following conditions.

(Powder X-Ray Diffraction Measurement)

Measuring machine used: X-ray diffraction apparatus RINT-TTR II manufactured by Rigaku Corporation.

X-ray tube: Cu

X-ray wavelength: Kα1

Tube voltage: 50 KV

Tube current: 300 mA

Scanning method: 2θ scan

Scanning speed: 4.0°/min

Sampling interval: 0.02°

Start angle (2θ): 5.0°

Stop angle (2θ): 35.0°

Goniometer: rotor horizontal goniometer (TTR-2)

Attachment: capillary rotary sample stage

Filter: none

Detector: scintillation counter

Incident monochromator: used

Slit: variable slit (parallel beam method)

Counter monochromator: not used

Divergence slit: open

Divergence vertical limiting slit: 10.00 mm

Scattering slit: open

Light receiving slit: open

It is preferable for a content of the charge generation material in the charge generation layer to be 50 to 85% by mass, and is more preferable to be 65 to 75% by mass, with respect to a total mass of the charge generation layer. When the content of the charge generation material in the charge generation layer is less than 50% by mass, contact between particles of the charge generation material decreases, and there is a case where charge transfer becomes insufficient particularly under a low electric field; and when the content is more than 85% by mass, the binder resin cannot sufficiently exist between the particles of the charge generation material, possibly resulting in a point in which electric charges are accumulated, and accordingly there is a case where the slope α of the linear approximation straight line becomes large which represents the electric field strength dependency.

Examples of the resin include a polyester resin, a polycarbonate resin, a polyvinyl acetal resin, a polyvinyl butyral resin, an acrylic resin, a silicone resin, an epoxy resin, a melamine resin, a polyurethane resin, a phenol resin, a polyvinyl alcohol resin, a cellulose resin, a polystyrene resin, a polyvinyl acetate resin and a polyvinyl chloride resin. Among the resins, the polyvinyl butyral resin is more preferable.

In addition, the charge generation layer may further contain additives such as an antioxidizing agent and an ultraviolet absorbing agent. Specific additives include a hindered phenol compound, a hindered amine compound, a sulfur compound, a phosphorus compound and a benzophenone compound.

An average film thickness of the charge generation layer of the present disclosure is 0.2 μm or larger.

The charge generation layer can be formed by preparing a coating liquid for the charge generation layer which contains each of the above described materials and a solvent, forming a coating film of the coating liquid on the support, the electroconductive layer or the undercoat layer, and drying the coating film. Examples of the solvent to be used for the coating liquid include an alcohol-based solvent, a sulfoxide-based solvent, a ketone-based solvent, an ether-based solvent, an ester-based solvent and an aromatic hydrocarbon-based solvent.

### Charge Transport Layer

It is preferable that the charge transport layer contains a charge transport material and a resin.

Examples of the charge transport material include a polycyclic aromatic compound, a heterocyclic compound, a hydrazone compound, a styryl compound, an enamine compound, a benzidine compound, a triarylamine compound, and resins having a group derived from these materials. Among the materials, a material having an ionization potential of 5.2 to 5.4 eV is preferable so as to obtain the effect of the present application. When the ionization potential is smaller than 5.2 eV, the a is large which represents the electric field strength dependency, and there is a case where the memory phenomenon deteriorates after the endurance; and when the ionization potential is larger than 5.4 eV, there has been a case where the residual charge increases.

Regarding measurement of the ionization potential, the threshold energy for releasing an electron was measured with the use of an atmospheric photoelectron spectroscopic apparatus (trade name: AC-2) manufactured by Riken Keiki Co., Ltd., and the ionization potential was measured.

It is preferable for a content of the charge transport material in the charge transport layer to be 25 to 70% by mass, and is more preferable to be 30 to 55% by mass, with respect to a total mass of the charge transport layer.

Examples of the resin include a polyester resin, a polycarbonate resin, an acrylic resin and a polystyrene resin. Among the resins, the polycarbonate resin and the polyester resin are preferable. In the polyester resins, a polyarylate resin is particularly preferable.

A content ratio (mass ratio) between the charge transport material and the resin is preferably 4:10 to 20:10, and is more preferably 5:10 to 12:10.

In addition, the charge transport layer may contain additives such as an antioxidizing agent, an ultraviolet absorbing agent, a plasticizing agent, a leveling agent, a slipperiness imparting agent and an abrasion resistance improver. The specific additives include a hindered phenol compound, a hindered amine compound, a sulfur compound, a phosphorus compound, a benzophenone compound, a siloxane modified resin, silicone oil, a fluorocarbon resin particle, a polystyrene resin particle, a polyethylene resin particle, a silica particle, an alumina particle and a boron nitride particle.

It is preferable for an average film thickness of the charge transport layer to be 5 to 50 μm, is more preferable to be 8 to 40 μm, and is particularly preferable to be 10 to 30 μm.

The charge transport layer can be formed by preparing a coating liquid for the charge transport layer which contains each of the above described materials and a solvent, forming a coating film of the coating liquid on the charge generation layer, and drying the coating film. Examples of the solvent to be used for the coating liquid include an alcohol-based solvent, a ketone-based solvent, an ether-based solvent, an ester-based solvent and an aromatic hydrocarbon-based solvent. Among the solvents, the ether-based solvent or the aromatic hydrocarbon-based solvent is preferable.

### Protective Layer

In the present disclosure, a protective layer may be provided on the photosensitive layer. By providing the protective layer, durability can be improved.

It is preferable that the protective layer contains an electroconductive particle and/or a charge transport material, and a resin.

Examples of the electroconductive particle include particles of metal oxides such as titanium oxide, zinc oxide, tin oxide and indium oxide.

Examples of the charge transport material include a polycyclic aromatic compound, a heterocyclic compound, a hydrazone compound, a styryl compound, an enamine compound, a benzidine compound, a triarylamine compound, and resins having a group derived from these materials. Among the materials, the triarylamine compound and the benzidine compound are preferable.

Examples of the resin include a polyester resin, an acrylic resin, a phenoxy resin, a polycarbonate resin, a polystyrene resin, a phenol resin, a melamine resin and an epoxy resin. Among the resins, the polycarbonate resin, the polyester resin and the acrylic resin are preferable.

In addition, the protective layer may be formed also as a cured film by the polymerization of a composition which contains a monomer having a polymerizable functional group. Examples of a reaction at this time include a thermal polymerization reaction, a photopolymerization reaction, and a radiation-induced polymerization reaction. Examples of the polymerizable functional group which the monomer having a polymerizable functional group has include an acryloyl group and a methacryloyl group. As a monomer having the polymerizable functional group, a material having charge transport capability may be used.

In addition, the protective layer may contain additives such as an antioxidizing agent, an ultraviolet absorbing agent, a plasticizing agent, a leveling agent, a slipperiness imparting agent and an abrasion resistance improver. The specific additives include a hindered phenol compound, a hindered amine compound, a sulfur compound, a phosphorus compound, a benzophenone compound, a siloxane modified resin, silicone oil, a fluorocarbon resin particle, a polystyrene resin particle, a polyethylene resin particle, a silica particle, an alumina particle and a boron nitride particle.

It is preferable for an average film thickness of the protective layer to be 0.5 to 10 μm, and is more preferable to be 1 to 7 μm.

The protective layer can be formed by preparing a coating liquid for the protective layer which contains each of the above described materials and a solvent, forming a coating film of the coating liquid on the photosensitive layer, and drying and/or curing the coating film. Examples of the solvent to be used for the coating liquid include an alcohol-based solvent, a ketone-based solvent, an ether-based solvent, a sulfoxide-based solvent, an ester-based solvent and an aromatic hydrocarbon-based solvent.

### Process Cartridge and Electrophotographic Apparatus

A process cartridge of the present disclosure includes: integrally supporting the electrophotographic photosensitive member described above, and at least one unit selected from the group consisting of a charging unit, a developing unit, a transfer unit and a cleaning unit; and being detachably attachable to a main body of an electrophotographic apparatus.

In addition, an electrophotographic apparatus of the present disclosure includes: the electrophotographic photosensitive member described above; a charging unit; an exposure unit; a developing unit; and a transfer unit.

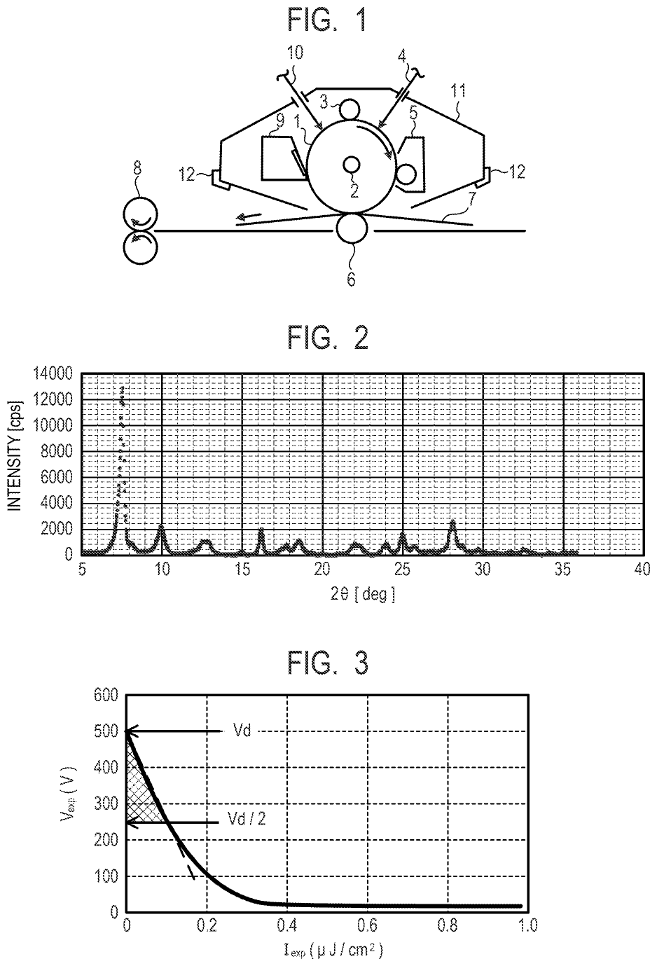

FIG. 1 illustrates one example of a schematic configuration of an electrophotographic apparatus that has a process cartridge provided with the electrophotographic photosensitive member.

Reference numeral 1 denotes a cylindrical electrophotographic photosensitive member which is rotationally driven around a shaft 2 in a direction of an arrow at a predetermined circumferential velocity. The surface of the electrophotographic photosensitive member 1 is electrostatically charged to a predetermined positive or negative potential by a charging unit 3. For information, in FIG. 1, a roller charging system by a roller type charging member is illustrated, but a charging system such as a corona charging system, a proximity charging system or an injection charging system may also be adopted. The surface of the electrostatically charged electrophotographic photosensitive member 1 is irradiated with exposure light 4 emitted from an exposure unit (not illustrated), and an electrostatic latent image corresponding to objective image information is formed on the surface. The electrostatic latent image formed on the surface of the electrophotographic photosensitive member 1 is developed by a toner accommodated in a developing unit 5, and a toner image is formed on the surface of the electrophotographic photosensitive member 1. The toner image formed on the surface of the electrophotographic photosensitive member 1 is transferred onto a transfer material 7 by a transfer unit 6. The transfer material 7 onto which the toner image has been transferred is conveyed to a fixing unit 8, is subjected to fixing treatment of the toner image, and is printed out to the outside of the electrophotographic apparatus. The electrophotographic apparatus may have a cleaning unit 9 for removing an adherent such as a toner remaining on the surface of the electrophotographic photosensitive member 1 after transferring. Alternatively, a cleaning unit may not be separately provided, but a so-called cleanerless system may be used that removes the above adherent by a developing unit or the like. The electrophotographic apparatus may have a diselectrifying mechanism that subjects the surface of the electrophotographic photosensitive member 1 to a diselectrifying process by pre-exposure light 10 emitted from a pre-exposure unit (not illustrated). In addition, a guiding unit 12 such as a rail may also be provided in order to detachably attach the process cartridge 11 of the present disclosure to a main body of the electrophotographic apparatus.

The electrophotographic photosensitive member of the present disclosure can be used in a laser beam printer, an LED printer, a copying machine, a facsimile, a combined machine thereof and the like.

### EXAMPLES

The present disclosure will be described below in more detail with reference to Examples and Comparative Examples. The present disclosure is not limited to the following Examples at all, as long as the present disclosure does not exceed the gist thereof. For information, the term “part(s)” in the description of the following Examples is on a mass basis, unless otherwise particularly noted.

### Synthesis of Phthalocyanine Pigment

### Synthesis Example 1

Under an atmosphere of nitrogen flow, 5.46 parts of orthophthalonitrile and 45 parts of a-chloronaphthalene were charged into a reaction vessel, and then were heated to raise the temperature to 30° C.; and this temperature was maintained. Next, 3.75 parts of gallium trichloride were charged there at this temperature (30° C.). The water concentration of the mixed liquid at the time of the charging was 150 ppm. After that, the temperature was raised to 200° C. Next, the mixed liquid was subjected to a reaction at a temperature of 200° C. for 4.5 hours under an atmosphere of nitrogen flow, and then was cooled, and when the temperature reached 150° C., the product was filtered. The obtained residue was dispersed and cleaned with the use of N,N-dimethylformamide, at a temperature of 140° C. for 2 hours, and then was filtered. The obtained residue was cleaned with methanol, and then was dried; and a chlorogallium phthalocyanine pigment was obtained at a yield of 71%.

### Synthesis Example 2

The chlorogallium phthalocyanine pigment in an amount of 4.65 parts, which was obtained in the Synthesis Example 1, was dissolved in 139.5 parts of concentrated sulfuric acid at a temperature of 10° C.; the mixture was added dropwise to 620 parts of ice water under stirring; the pigment was reprecipitated; and the mixture was filtered under reduced pressure with the use of a filter press. At this time, No. 5C (manufactured by Advantec Co., Ltd.) was used as the filter. The obtained wet cake (residue) was dispersed and cleaned with 2% aqueous ammonia for 30 minutes, and then the mixture was filtered with the use of a filter press. Next, the obtained wet cake (residue) was dispersed and cleaned with ion-exchanged water, and then filtration using a filter press was repeated 3 times. In the end, the residue was subjected to freeze-drying (freeze-drying), and a hydroxygallium phthalocyanine pigment (hydrated hydroxygallium phthalocyanine pigment) having a solid content of 23% was obtained at a yield of 97%.

### Synthesis Example 3

The hydrated hydroxygallium phthalocyanine pigment in an amount of 6.6 kg, which was obtained in the Synthesis Example 2, was dried in the following way, with the use of a hyper dry drying machine (trade name: HD-06R, frequency (oscillation frequency): 2455 MHz±15 MHz, manufactured by Biocon (Japan) Ltd.).

The above hydroxygallium phthalocyanine pigment was placed on a dedicated circular plastic tray, in a state of a lump (hydrated cake thickness of 4 cm or smaller) immediately after having been taken out from the filter press; and far infrared rays were turned off, and the temperature of the inner wall of the drying machine was set so as to become 50° C. Then, at the time of microwave irradiation, the vacuum pump and the leak valve were adjusted so that the vacuum degree became 4.0 to 10.0 kPa.

Firstly, in a first step, the hydroxygallium phthalocyanine pigment was irradiated with a microwave of 4.8 kW for 50 minutes; subsequently, the microwave was once turned off, and the leak valve was once closed; and the drying machine was adjusted to become a high vacuum of 2 kPa or lower. The solid content of the hydroxygallium phthalocyanine pigment was 88% at this point in time. In a second step, the leak valve was adjusted, and the degree of vacuum (pressure in the drying machine) was adjusted to within the above set value (4.0 to 10.0 kPa). After that, the hydroxygallium phthalocyanine pigment was irradiated with the microwave of 1.2 kW for 5 minutes; the microwave was once turned off, and the leak valve was once closed; and the drying machine was adjusted to become a high vacuum of 2 kPa or lower. This second step was further repeated one more time (two times in total). The solid content of the hydroxygallium phthalocyanine pigment was 98% at this point in time. Furthermore, in a third step, the pigment was irradiated with the microwave in the same manner as in the second step, except that the microwave output in the second step was changed from 1.2 to 0.8 kW. This third step was further repeated one more time (two times in total). Furthermore, in a fourth step, the leak valve was adjusted, and the vacuum degree (pressure in the drying machine) was restored to within the above set value (4.0 to 10.0 kPa). After that, the hydroxygallium phthalocyanine pigment was irradiated with the microwave of 0.4 kW for 3 minutes; the microwave was once turned off, and the leak valve was once closed; and the drying machine was adjusted to become a high vacuum of 2 kPa or lower. This fourth step was further repeated seven times (eight times in total). Thus, in a total of 3 hours, 1.52 kg of the hydroxygallium phthalocyanine pigment (crystal) was obtained of which the water content was 1% or less.

### Synthesis Example 4

Thirty parts of 1,3-diiminoisoindoline and 9.1 parts of gallium trichloride were added to 230 parts of dimethyl sulfoxide, and the mixture was reacted at 160° C. for 6 hours while being stirred; and a reddish-purple pigment was obtained. The obtained pigment was cleaned with dimethyl sulfoxide, then cleaned with ion-exchanged water, and dried; and 28 parts of a chlorogallium phthalocyanine pigment was obtained.

### Synthesis Example 5

A solution was obtained by sufficiently dissolving 10 parts of the chlorogallium phthalocyanine pigment obtained in the Synthesis Example 4 in 300 parts of sulfuric acid (concentration of 97%) which was heated to 60° C., and was added dropwise to a mixed solution of 600 parts of 25% ammonia water and 200 parts of ion-exchanged water. The precipitated pigment was collected by filtration, cleaned with N,N-dimethylformamide and ion-exchanged water, and dried; and 8 parts of a hydroxygallium phthalocyanine pigment was obtained.

### Example 1

### Support

An aluminum cylinder with a diameter of 24 mm and a length of 257 mm was used as a support (electroconductive cylindrical support).

### Electroconductive Layer

As a base substance, anatase-type titanium oxide of which the average size of primary particles was 200 nm was used, and a titanium niobium sulfate solution was prepared which contained 33.7 parts of titanium in terms of TiO₂ and 2.9 parts of niobium in terms of Nb₂O₅. In pure water, 100 parts of the base substance were dispersed to prepare 1000 parts of a suspension liquid, and the suspension liquid was heated to 60° C. The titanium niobium sulfate solution and a 10 mol/L solution of sodium hydroxide were added dropwise to the suspension liquid over 3 hours so that a pH of the suspension liquid became 2 to 3. After the whole quantity was added dropwise, the pH was adjusted to the vicinity of neutrality, and a polyacrylamide-based flocculant was added to settle a solid content. The supernatant was removed, the rest was filtered, and the residue was cleaned and then dried at 110° C. to obtain an intermediate which contained 0.1 wt % of an organic substance which was derived from the flocculant, in terms of C. This intermediate was calcined in nitrogen gas at 750° C. for 1 hour, then was calcined at 450° C. in air, and a titanium oxide particle 1 was produced. An average particle size (average primary particle size) of the obtained particles was 220 nm in the particle size measurement method using a scanning electron microscope.

Subsequently, 50 parts of a phenol resin (monomer/oligomer of phenol resin) (trade name: Priophen J-325, produced by DIC Corporation, resin solid content: 60%, and density after curing: 1.3 g/cm³) as a binder material were dissolved in 35 parts of 1-methoxy-2-propanol as a solvent, and a solution was obtained.

To the solution, 60 parts of the titanium oxide particle 1 was added; the resultant liquid was used as a dispersion medium, and was charged into a vertical sand mill which used 120 parts of glass beads having an average particle size of 1.0 mm; the mixture was subjected to dispersion treatment under conditions of a dispersion liquid temperature of 23±3° C. and a number of rotations of 1500 rpm (circumferential velocity: 5.5 m/s) for 4 hours; and a dispersion liquid was obtained. The glass beads were removed from the dispersion liquid with a mesh. Into the dispersion liquid from which the glass beads were removed, 0.01 parts of silicone oil (trade name: SH28 PAINT ADDITIVE, produced by Dow Corning Toray Co., Ltd.) as a leveling agent, and 8 parts of a silicone resin particle (trade name: KMP-590, produced by Shin-Etsu Chemical Co., Ltd., average particle size: 2 μm, and density: 1.3 g/cm³) as a surface roughness imparting material were added; the mixture was stirred, and was pressure filtrated with the use of a PTFE filter paper (trade name: PF060, produced by Advantec Toyo Kaisha, Ltd.); and a coating liquid for an electroconductive layer was thereby prepared.

The above described support was dip-coated with the thus prepared coating liquid for the electroconductive layer to form a coating film thereon, the coating film was heated at 150° C. for 20 minutes to be cured, and thereby, the electroconductive layer was formed of which the film thickness was 15 μm.

### Undercoat Layer

One hundred parts of a rutile-type titanium dioxide particle (average primary particle size: 50 nm, produced by Tayca Corporation) were stirred and mixed with 500 parts of toluene, 3.0 parts of vinyltrimethoxysilane (trade name: KBM-1003, produced by Shin-Etsu Chemical Co., Ltd.) were added thereto, and the mixture was stirred for 8 hours. After that, the toluene was distilled off under reduced pressure, the resultant product was dried at 120° C. for 3 hours, and thereby a rutile-type titanium dioxide particle was obtained which was already surface-treated with vinyltrimethoxysilane.

Eighteen parts of the above rutile-type titanium dioxide particle which was surface-treated with the vinyltrimethoxysilane, 4.5 parts of N-methoxymethylated nylon (trade name: Toresin EF-30T, produced by Nagase ChemteX Corporation), and 1.5 parts of a copolymerized nylon resin (trade name: Amilan™ CM8000, produced by Toray Industries, Inc.) were added into a mixed solvent of 90 parts of methanol and 60 parts of 1-butanol, and a dispersion liquid was prepared. This dispersion liquid was subjected to dispersion treatment for 6 hours in a vertical sand mill using glass beads having a diameter of 1.0 mm, and thereby a coating liquid for an undercoat layer was prepared.

The electroconductive layer described above was dip-coated with the coating liquid for the undercoat layer to form a coating film thereon, and the coating film was heated and dried at a temperature of 100° C. for 10 minutes; and an undercoat layer having a film thickness of 1 μm was formed.

### Charge Generation Layer

Next, 0.5 parts of the hydroxygallium phthalocyanine pigment obtained in Synthesis Example 3, 9.5 parts of N-methylformamide (product code: F0059, produced by Tokyo Chemical Industry Co., Ltd.), and 15 parts of glass beads having a diameter of 0.9 mm were subjected to milling treatment in a paint shaker (manufactured by Toyo Seiki Seisaku-sho, Ltd.) at room temperature (23° C.) for 6 hours (first stage). At this time, a standard bottle (product name: PS-6, manufactured by Hakuyo Glass Co., Ltd.) was used as the container. The liquid thus subjected to the milling treatment was filtered through a filter (product number: N-NO. 125T, pore size: 133 μm, produced by NBC Meshtec Inc.), and glass beads were removed. This liquid was subjected to milling treatment in a ball mill at room temperature (23° C.) for 40 hours (second stage). At this time, the standard bottle (product name: PS-6, manufactured by Hakuyo Glass Co., Ltd.) was used as the container, and the milling treatment was performed under the condition that the container rotated at 120 rotations per minute. In addition, media such as the glass beads were not used in this milling treatment. To thus treated liquid, 30 parts of N-methylformamide were added, then the mixture was filtered, and then, the filtration residue on the filter was sufficiently cleaned with tetrahydrofuran. Then, the cleaned filtration residue was vacuum-dried, and 0.46 parts of a hydroxygallium phthalocyanine pigment was obtained.

The obtained hydroxygallium phthalocyanine pigment has peaks at 7.4°±0.3°, 9.9°+0.3°, 16.2°+0.3°, 18.6°±0.3°, 25.2°±0.3° and 28.2°±0.3° at Bragg angle 2θ in a spectrum of X-ray diffraction using a CuKαray. The crystal correlation lengths estimated from the peaks at 7.4°±0.3° and 28.2°±0.3°, which were the strongest diffraction peaks in a range of 5° to 35° were r₁=31 [nm] and r₂=19 [nm], respectively. Accordingly, the value of A obtained from Expression (4) is 0.60. Subsequently, 20 parts of the hydroxygallium phthalocyanine pigment obtained in the milling treatment, 10 parts of polyvinyl butyral (trade name: S-LEC BX-1, produced by Sekisui Chemical Co., Ltd.), 190 parts of cyclohexanone and 482 parts of glass beads having a diameter of 0.9 mm were subjected to dispersion treatment at a cooling water temperature of 18° C. for 4 hours, with the use of a sand mill (K-800, manufactured by Igarashi Machine Production Co., Ltd. (now Aimex Co., Ltd.), disk diameter of 70 mm, and number of discs being 5 disks). At this time, the dispersion treatment was performed under the condition that the disk rotated at 1,800 rotations per minute. A coating liquid for a charge generation layer was prepared by adding 444 parts of cyclohexane and 634 parts of ethylacetate to the dispersion liquid. The undercoat layer described above was dip-coated with the coating liquid for the charge generation layer to form a coating film thereon, and the coating film was heated and dried at 100° C. for 10 minutes; and a charge generation layer having a film thickness of 0.23 μm was formed.

### Charge Transport Layer

As charge transport materials, 6 parts of the charge transport material having an ionization potential of 5.4 eV represented by the following Formula (B-1):

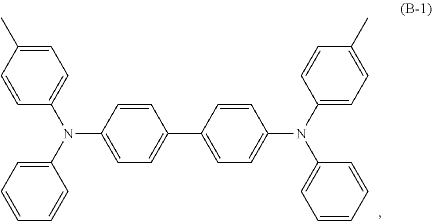 [SMILES: Cc1ccc(N(c2ccccc2)c2ccc(-c3ccc(N(c4ccccc4)c4ccc(C)cc4)cc3)cc2)cc1]

4 parts of a chemical compound of the charge transport material having the ionization potential of 5.3 eV, which was represented by the following Formula (B-2):

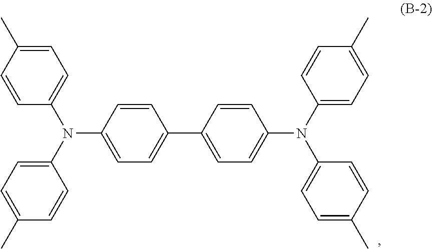 [SMILES: Cc1ccc(N(c2ccc(C)cc2)c2ccc(-c3ccc(N(c4ccc(C)cc4)c4ccc(C)cc4)cc3)cc2)cc1]

and 10 parts of polycarbonate (trade name: Iupilon Z-400, produced by Mitsubishi Engineering-Plastics Corporation) were dissolved in a mixed solvent of 25 parts of ortho-xylene/25 parts of methyl benzoate/25 parts of dimethoxymethane; and a coating liquid for a charge transport layer was prepared.

The charge generation layer described above was dip-coated with the thus prepared coating liquid for the charge transport layer to form a coating film thereon, and the coating film was heated and dried at 120° C. for 30 minutes; and a charge transport layer was formed of which the film thickness was 25 μm.

With the use of the thus produced electrophotographic photosensitive member, Pₑ, α, η₀ and Vᵣ were measured by the previously described method, in an environment at a temperature of 23.5° C. and a relative humidity of 50% RH, and the electrophotographic photosensitive member was evaluated based on the following memory evaluation method. The results are shown in Table 1.

### Evaluation of Memory

As an electrophotographic apparatus for the evaluation, a laser beam printer (trade name: Laser Jet Enterprise M653) manufactured by HP Inc. was prepared, and was modified so that pre-exposure was eliminated and a process speed, a voltage applied to a charging roller, and a quantity of image exposure light could be adjusted.

As for the modification, the process speed was changed to 200 mm/s, a dark portion potential was set to −500 V, and a light quantity of the exposure light (image exposure light) was made variable.

The details are as follows.

Under an environment of a temperature of 23° C. and a humidity of 50% RH, a process cartridge for a cyan color of the above laser beam printer was modified: a potential probe (model 6000B-8: manufactured by Trek Japan Co. Ltd.) was mounted to a developing position, and an electrophotographic photosensitive member for evaluation of positive ghost and potential variation was mounted; and a potential at the center of the electrophotographic photosensitive member was measured with the use of a surface electrometer (model 344: manufactured by Trek Japan K. K.). The quantity of the exposure light was set so that among the surface potentials of the electrophotographic photosensitive member, the dark portion potential (Vd) became −500 V and the light portion potential (V1) became −100 V.

Next, the electrophotographic photosensitive member described above was mounted in the process cartridge for the cyan color of the above laser beam printer, then the process cartridge was mounted in a station of the process cartridge for the cyan, and an image was output. Firstly, images were continuously output in order of one sheet of a solid white image, 5 sheets of images for ghost evaluation, one sheet of a solid black image, and 5 sheets of images for ghost evaluation.

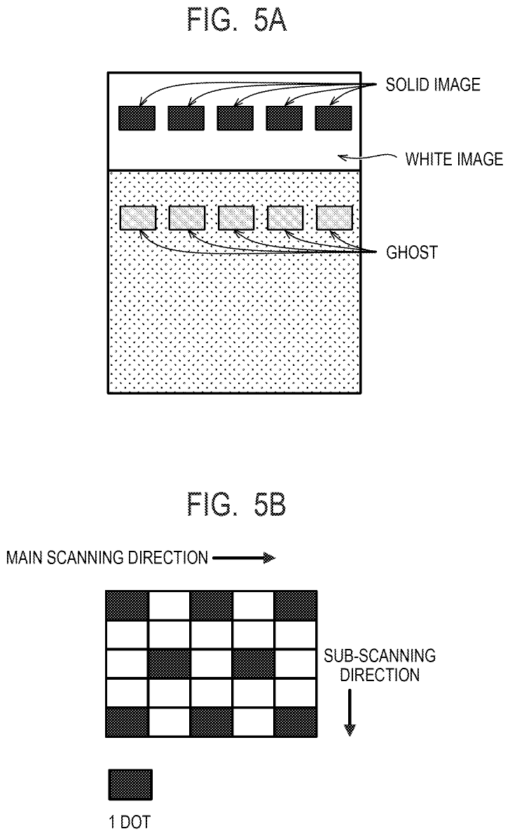

The ghost evaluation images are images in which as shown in FIG. 5A, a square “solid image” is displayed in a “white image” at a head portion of the image, and a “halftone image of one dot knight pattern” illustrated by FIG. 5B is created. For information, in the FIG. 5A, the “ghost” portion is a portion in which the ghost caused by the “solid image” can appear.

The positive ghost was evaluated by measuring a density difference between an image density of a halftone image of the one dot knight pattern and an image density of the ghost portion. The difference between the densities was measured at 10 points in one image for ghost evaluation, with a spectrodensitometer (trade name: X Rite 504/508, manufactured by X-Rite K. K.). This operation was performed for all of the 10 sheets of the images for the ghost evaluation, and an average of 100 points in total was calculated. The evaluation criteria of the memory based on the difference between the image density of the halftone image and the density of the ghost portion are as follows. For information, in the memory evaluation, the initial memory and the memory after the endurance after the image output were evaluated.

In the present disclosure, in the case where the memory was evaluated as A, B or C, it was regarded that the effect of the present disclosure was obtained.

The evaluation results are shown in Table 1.

A: The density difference is 0.00 or larger and smaller than 0.01, and the difference is not visually observed.

B: The density difference is 0.01 or larger and smaller than 0.03, and the difference in not almost visually observed.

C: The density difference is 0.03 or larger and smaller than 0.05, and a slight difference is visually observed.

D: The density difference is 0.05 or larger and smaller than 0.08, and an apparent difference is visually observed.

E: The density difference is 0.08 or larger, and a great difference is visually observed.

### Example 2

An electrophotographic photosensitive member was produced in the same way as in Example 1 except that in the preparation of the coating liquid for the charge generation layer in Example 1, a time period of the milling treatment in the ball mill in the second stage was changed from 40 hours to 100 hours; with the use of the produced electrophotographic photosensitive member, Pₑ, α, η₀ and Vᵣ were measured by the previously described method, in an environment at a temperature of 23.5° C. and a relative humidity of 50% RH; and the electrophotographic photosensitive member was evaluated based on the previously described memory evaluation method. The results are shown in Table 1. The value of A of the obtained phthalocyanine pigment determined by Expression (4) was 0.7.

### Example 3

An electrophotographic photosensitive member was produced in the same way as in Example 1 except that in the preparation of the coating liquid for the charge generation layer in Example 1, the milling treatment was changed in the following way; and with the use of the produced electrophotographic photosensitive member, Pₑ, α, η₀ and Vᵣ were measured by the previously described method, in an environment at a temperature of 23.5° C. and a relative humidity of 50% RH; and the electrophotographic photosensitive member was evaluated based on the previously described memory evaluation method. The results are shown in Table 1.

### Preparation of Coating Liquid for Charge Generation Layer

One part of the hydroxygallium phthalocyanine pigment obtained in Synthesis Example 3 was dried under reduced pressure, and a pigment was obtained of which the water content was 6000 ppm. Next, a mixture of the obtained hydroxygallium phthalocyanine pigment, 9 parts of N-methylformamide (product code: F0059, produced by Tokyo Chemical Industry Co., Ltd.), and 15 parts of glass beads having a diameter of 0.9 mm were subjected to milling treatment under cooling water at a temperature of 18° C. for 43 hours with the use of the sand mill (K-800, manufactured by Igarashi Machine Production Co., Ltd. (now Aimex Co., Ltd.), disk size of 70 mm, and number of disks of 5). At this time, the milling treatment was performed under the condition that the disk rotated at 200 rotations per minute. In addition, because the water content of N-methylformamide before the charging was 1000 ppm, the water content in the system was 1550 ppm. To the thus treated liquid, 30 parts of N-methylformamide were added, then the mixture was filtered, and then, the filtration residue on the filter was sufficiently cleaned with tetrahydrofuran. Then, the cleaned filtration residue was vacuum-dried, and 0.45 parts of a hydroxygallium phthalocyanine pigment was obtained. The value of A of the obtained phthalocyanine pigment determined by Expression (4) was 0.8.

### Example 4

An electrophotographic photosensitive member was produced in the same way as in Example 1 except that in the preparation of the coating liquid for the charge generation layer in Example 1, the step of obtaining the hydroxygallium phthalocyanine pigment was changed in the following way; with the use of the produced electrophotographic photosensitive member, Pₑ, α, η₀ and Vᵣ were measured by the previously described method, in an environment at a temperature of 23.5° C. and a relative humidity of 50% RH; and the electrophotographic photosensitive member was evaluated based on the previously described memory evaluation method. The results are shown in Table 1.

### Preparation of Coating Liquid for Charge Generation Layer

The hydroxygallium phthalocyanine pigment in an amount of 0.5 parts, which was obtained in Synthesis Example 5, and 8 parts of N,N-dimethylformamide (product code: D0722, produced by Tokyo Chemical Industry Co., Ltd.) was subjected to milling treatment with a magnetic stirrer at a temperature of 30° C. for 24 hours (first stage). At this time, the standard bottle (product name: PS-6, manufactured by Hakuyo Glass Co., Ltd.) was used as the container, and the milling treatment was performed under the condition that a rotor rotated at 1,500 rotations per minute. To the thus treated liquid, 30 parts of N,N-dimethylformamide were added, then the mixture was filtered, and then, the filtration residue on the filter was sufficiently cleaned with ion-exchanged water. Then, the cleaned filtration residue was vacuum-dried, and 0.45 parts of a hydroxygallium phthalocyanine pigment was obtained. Subsequently, 0.5 parts of the obtained hydroxygallium phthalocyanine pigment and 5 parts of zirconia beads having a diameter of 5.0 mm were subjected to milling treatment at room temperature (23° C.) for 5 minutes, with the use of a small vibration mill (Model MB-0, manufactured by Chuo Kakohki Co., Ltd.) (second stage). At this time, a pot made from alumina was used as a container. Thus, 0.48 parts of a hydroxygallium phthalocyanine pigment was obtained. The value of A of the obtained phthalocyanine pigment determined by Expression (4) was 0.83.

### Example 5

An electrophotographic photosensitive member was produced in the same way as in Example 1 except that in the preparation of the coating liquid for the charge generation layer in Example 1, the step of obtaining the hydroxygallium phthalocyanine pigment was changed in the following way; with the use of the produced electrophotographic photosensitive member, Pₑ, α, η₀ and Vᵣ were measured by the previously described method, in an environment at a temperature of 23.5° C. and a relative humidity of 50% RH; and the electrophotographic photosensitive member was evaluated based on the previously described memory evaluation method. The results are shown in Table 1.

### Preparation of Coating Liquid for Charge Generation Layer

A mixture of 1 part of the hydroxygallium phthalocyanine pigment obtained in Synthesis Example 3, 9 parts of N-methylformamide (product code: F0059, produced by Tokyo Chemical Industry Co., Ltd.), and 15 parts of glass beads having a diameter of 0.9 mm were subjected to milling treatment under cooling water at a temperature of 18° C. for 70 hours with the use of the sand mill (K-800, manufactured by Igarashi Machine Production Co., Ltd. (now Aimex Co., Ltd.), disk size of 70 mm, and number of disks of 5). At this time, the milling treatment was performed under the condition that the disk rotated at 400 rotations per minute. To the thus treated liquid, 30 parts of N-methylformamide were added, then the mixture was filtered, and then, the filtration residue on the filter was sufficiently cleaned with tetrahydrofuran. Then, the cleaned filtration residue was vacuum-dried, and 0.45 parts of a hydroxygallium phthalocyanine pigment was obtained. The value of A of the obtained phthalocyanine pigment determined by Expression (4) was 0.5.

### Example 6

An electrophotographic photosensitive member was produced in the same way as in Example 1 except that in the preparation of the coating liquid for the charge generation layer in Example 1, 20 parts of the hydroxygallium phthalocyanine pigment obtained by the milling treatment were changed to 25 parts; with the use of the produced electrophotographic photosensitive member, Pₑ, α, η₀ and Vᵣ were measured by the previously described method, in an environment at a temperature of 23.5° C. and a relative humidity of 50% RH; and the electrophotographic photosensitive member was evaluated based on the previously described memory evaluation method. The results are shown in Table 1.

### Examples 7 to 9

Electrophotographic photosensitive members were produced in the same way as in Example 1 except that in the preparation of the coating liquid for the charge generation layer in Example 1, 20 parts of the hydroxygallium phthalocyanine pigment obtained by the milling treatment were changed to 30 parts, 18 parts and 15 parts, respectively; with the use of the produced electrophotographic photosensitive members, Pₑ, α, η₀ and Vᵣ were measured by the previously described method, in an environment at a temperature of 23.5° C. and a relative humidity of 50% RH; and the electrophotographic photosensitive members were evaluated based on the previously described memory evaluation method. The results are shown in Table 1.

### Examples 10 to 13

Electrophotographic photosensitive members were produced in the same way as in Example 1 except that the film thickness of the charge generation layer in Example 1 was changed from 0.23 μm to 0.20 μm, 0.25 μm, 0.30 μm and 0.40 μm, respectively; with the use of the produced electrophotographic photosensitive members, Pₑ, α, η₀ and Vᵣ were measured by the previously described method, in an environment at a temperature of 23.5° C. and a relative humidity of 50% RH; and the electrophotographic photosensitive members were evaluated based on the previously described memory evaluation method. The results are shown in Table 1.

### Example 14

An electrophotographic photosensitive member was produced in the same way as in Example 1 except that the coating liquid for the charge transport layer in Example 1 was prepared in the following way; with the use of the produced electrophotographic photosensitive member, Pₑ, α, η₀ and Vᵣ were measured by the previously described method, in an environment at a temperature of 23.5° C. and a relative humidity of 50% RH; and the electrophotographic photosensitive member was evaluated based on the previously described memory evaluation method. The results are shown in Table 1.

### Coating Liquid for Charge Transport Layer

As a charge transport material, 10 parts of the charge transport material having an ionization potential of 5.5 eV represented by the following Formula (B-3):

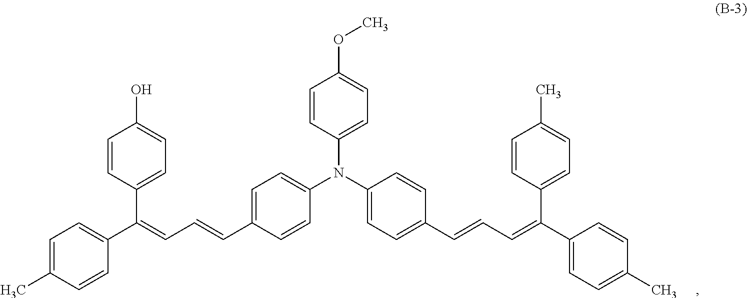

and 10 parts of polycarbonate (trade name: Iupilon Z-400, produced by Mitsubishi Engineering-Plastics Corporation) were dissolved in a mixed solvent of 50 parts of ortho-xylene/25 parts of THF; and a coating liquid for a charge transport layer was prepared.

### Example 15

An electrophotographic photosensitive member was produced in the same way as in Example 1 except that the coating liquid for the charge transport layer in Example 1 was prepared in the following way; with the use of the produced electrophotographic photosensitive member, Pₑ, α, η₀ and Vᵣ were measured by the previously described method, in an environment at a temperature of 23.5° C. and a relative humidity of 50% RH; and the electrophotographic photosensitive member was evaluated based on the previously described memory evaluation method. The results are shown in Table 1.

### Coating Liquid for Charge Transport Layer

As a charge transport material, 10 parts of the charge transport material having an ionization potential of 5.5 eV represented by the following Formula (B-4):

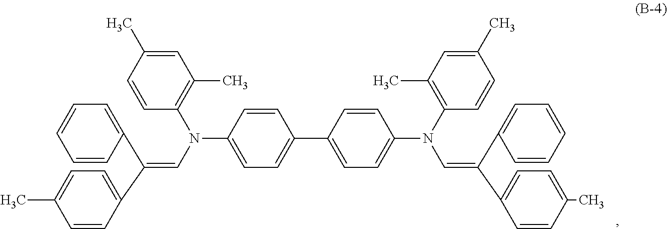

and 10 parts of polycarbonate (trade name: Iupilon Z-400, produced by Mitsubishi Engineering-Plastics Corporation) were dissolved in a mixed solvent of 25 parts of ortho-xylene/25 parts of methyl benzoate/25 parts of dimethoxymethane; and a coating liquid for a charge transport layer was prepared.

### Example 16

An electrophotographic photosensitive member was produced in the same way as in Example 15 except that the charge transport material (B-4) in Example 15 was changed to the charge transport material (B-1); with the use of the produced electrophotographic photosensitive member, Pₑ, α, η₀ and Vᵣ were measured by the previously described method, in an environment at a temperature of 23.5° C. and a relative humidity of 50% RH; and the electrophotographic photosensitive member was evaluated based on the previously described memory evaluation method. The results are shown in Table 1.

### Example 17

An electrophotographic photosensitive member was produced in the same way as in Example 15 except that the charge transport material (B-4) in Example 15 was changed to the charge transport material (B-2); with the use of the produced electrophotographic photosensitive member, Pₑ, α, η₀ and Vᵣ were measured by the previously described method, in an environment at a temperature of 23.5° C. and a relative humidity of 50% RH; and the electrophotographic photosensitive member was evaluated based on the previously described memory evaluation method. The results are shown in Table 1.

### Example 18

An electrophotographic photosensitive member was produced in the same way as in Example 1 except that in the preparation of the coating liquid for the undercoat layer in Example 1, 12 parts of rutile-type titanium dioxide particles, which were surface-treated with vinyltrimethoxysilane, were changed to 18 parts; with the use of the produced electrophotographic photosensitive member, Pₑ, α, η₀ and Vᵣ were measured by the previously described method, in an environment at a temperature of 23.5° C. and a relative humidity of 50% RH; and the electrophotographic photosensitive member was evaluated based on the previously described memory evaluation method. The results are shown in Table 1.

### Example 19

An electrophotographic photosensitive member was produced in the same way as in Example 1 except that the coating liquid for the undercoat layer in Example 1 was prepared in the following way; with the use of the produced electrophotographic photosensitive member, Pₑ, α, η₀ and Vᵣ were measured by the previously described method, in an environment at a temperature of 23.5° C. and a relative humidity of 50% RH; and the electrophotographic photosensitive member was evaluated based on the previously described memory evaluation method. The results are shown in Table 1.

### Coating Liquid for Undercoat Layer

One hundred parts of a rutile-type titanium dioxide particle (average primary particle size: 15 nm, produced by Tayca Corporation) were stirred and mixed with 500 parts of toluene, 9.6 parts of vinyltrimethoxysilane (trade name: KBM-1003, produced by Shin-Etsu Chemical Co., Ltd.) were added thereto, and the mixture was stirred for 8 hours. After that, the toluene was distilled off under reduced pressure, the resultant product was dried at 120° C. for 3 hours, and thereby a rutile-type titanium dioxide particle was obtained which was already surface-treated with methyldimethoxysilane.

Six parts of the above rutile-type titanium dioxide particle which was surface-treated with the methyldimethoxysilane, 4.5 parts of N-methoxymethylated nylon (trade name: Toresin EF-30T, produced by Nagase ChemteX Corporation), and 1.5 parts of a copolymerized nylon resin (trade name: Amilan™ CM8000, produced by Toray Industries, Inc.) were added into a mixed solvent of 90 parts of methanol and 60 parts of 1-butanol, and a dispersion liquid was prepared. This dispersion liquid was subjected to dispersion treatment in a vertical sand mill with the use of glass beads having a diameter of 1.0 mm, for 6 hours. The liquid which was thus subjected to the sand mill dispersion treatment was then further subjected to dispersion treatment with the ultrasonic disperser (UT-205, manufactured by Sharp Corporation) for 1 hour, and thereby a coating liquid for an undercoat layer was prepared.

### Example 20

An electrophotographic photosensitive member was produced in the same way as in Example 1 except that in the preparation of the coating liquid for the undercoat layer in Example 1, vinyltrimethoxysilane was changed to methyldimethoxysilane (“TSL8117” produced by Toshiba Silicone Co., Ltd.); with the use of the produced electrophotographic photosensitive member, Pₑ, α, η₀ and Vᵣ were measured by the previously described method, in an environment at a temperature of 23.5° C. and a relative humidity of 50% RH; and the electrophotographic photosensitive member was evaluated based on the previously described memory evaluation method. The results are shown in Table 1.

### Example 21

An electrophotographic photosensitive member was produced in the same way as in Example 1 except that the undercoat layer in Example 3 was produced in the following way; with the use of the produced electrophotographic photosensitive member, Pₑ, α, η₀ and Vᵣ were measured by the previously described method, in an environment at a temperature of 23.5° C. and a relative humidity of 50% RH; and the electrophotographic photosensitive member was evaluated based on the previously described memory evaluation method. The results are shown in Table 1.

### Preparation of Coating Liquid for Undercoat Layer

N-methoxymethylated nylon (trade name: Toresin EF-30T, produced by Nagase ChemteX Corporation) in an amount of 4.5 parts, and 1.5 parts of a copolymerized nylon resin (trade name: Amilan™ CM8000, produced by Toray Industries, Inc.) were dissolved in a mixed solvent of 65 parts of methanol and 30 parts of 1-butanol, and thereby, a coating liquid for an undercoat layer was prepared.

The electroconductive layer described above was dip-coated with the coating liquid for the undercoat layer to form a coating film thereon, and the coating film was heated and dried at a temperature of 100° C. for 10 minutes; and an undercoat layer was formed of which the film thickness was 0.4 μm.

### Examples 22 to 27

Electrophotographic photosensitive members were produced in the same way as in Example 1 except that the film thickness of the charge transport layer in Example 1 was changed from 25 μm to 15 μm, 20 μm, 23 μm, 30 μm, 35 μm and 40 μm, respectively; with the use of the produced electrophotographic photosensitive members, Pₑ, α, η₀ and Vᵣ were measured by the previously described method, in an environment at a temperature of 23.5° C. and a relative humidity of 50% RH; and the electrophotographic photosensitive members were evaluated based on the previously described memory evaluation method. The results are shown in Table 1.

### Example 28

An electrophotographic photosensitive member was produced in the same way as in Example 17 except that in the preparation of the coating liquid for the charge transport layer in Example 17, 10 parts of polycarbonate was changed to a polyester resin that had structural units represented by the following formula (C-1) and the following formula (C-2) in which a molar ratio of (C-1) to (C-2) was 5/5, and that had a weight-average molecular weight was 120,000; with the use of the produced electrophotographic photosensitive member, Pₑ, α, η₀ and Vᵣ were measured by the previously described method, in an environment at a temperature of 23.5° C. and a relative humidity of 50% RH; and the electrophotographic photosensitive member was evaluated based on the previously described memory evaluation method. The results are shown in Table 1.

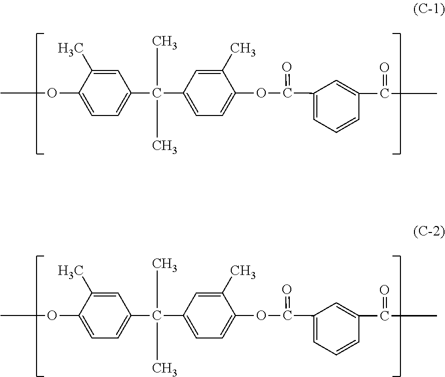

### Comparative Example 1

An electrophotographic photosensitive member was produced in the same way as in Example 21 except that in the preparation of the coating liquid for the charge transport layer in Example 21, 5 parts of the charge transport material (B-1)/5 parts of the charge transport material (B-2) were changed to 7 parts of a charge transport material which was represented by the following Formula (B-5) and had an ionization potential of 5.5 eV,

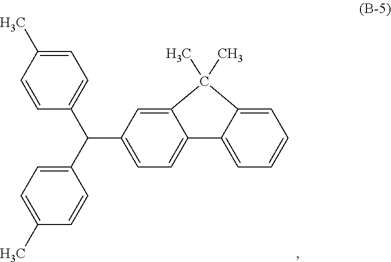 [SMILES: Cc1ccc(C(c2ccc(C)cc2)c2ccc3c(c2)C(C)(C)c2ccccc2-3)cc1]

and 1 part of a charge transport material which was represented by the following Formula (B-6) and had an ionization potential of 5.6 eV,

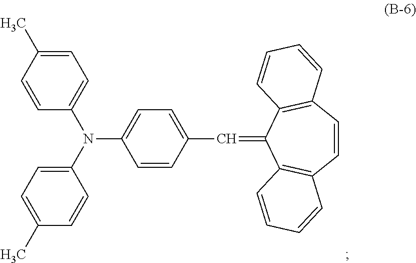 [SMILES: Cc1ccc(N(c2ccc(C)cc2)c2ccc(C=C3c4ccccc4C=Cc4ccccc43)cc2)cc1]

with the use of the produced electrophotographic photosensitive member, Pₑ, α, η₀ and Vᵣ were measured by the previously described method, in an environment at a temperature of 23.5° C. and a relative humidity of 50% RH; and the electrophotographic photosensitive member was evaluated based on the previously described memory evaluation method. The results are shown in Table 1.

### Comparative Example 2

An electrophotographic photosensitive member was produced in the same way as in Example 1 except that the film thickness of the charge generation layer in Example 1 was changed from 0.23 to 0.15 μm, and that in the preparation of the coating liquid for the charge transport layer, the charge transport material was changed to 5 parts of a charge transport material (B-5)/5 parts of a charge transport material (B-6); with the use of the produced electrophotographic photosensitive member, Pₑ, α, η₀ and Vᵣ were measured by the previously described method, in an environment at a temperature of 23.5° C. and a relative humidity of 50% RH; and the electrophotographic photosensitive member was evaluated based on the previously described memory evaluation method. The results are shown in Table 1.

### Comparative Example 3

An electrophotographic photosensitive member was produced in the same way as in Example 1 except that an undercoat layer, a charge generation layer and a charge transport layer in Example 2 described in Japanese Patent Application Laid-Open No. H09-114120 were produced on the support described in Example 1; with the use of the produced electrophotographic photosensitive member, Pₑ, α, η₀ and Vᵣ were measured by the previously described method, in an environment at a temperature of 23.5° C. and a relative humidity of 50% RH; and the electrophotographic photosensitive member was evaluated based on the previously described memory evaluation method. The results are shown in Table 1.

### Comparative Example 4

An electrophotographic photosensitive member was produced in the same way as in Example 1 except that an undercoat layer, a charge generation layer and a charge transport layer in Example 1 described in Japanese Patent Application Laid-Open No. H10-069109 were produced on the support described in Example 1; with the use of the produced electrophotographic photosensitive member, Pₑ, α, η₀ and Vᵣ were measured by the previously described method, in an environment at a temperature of 23.5° C. and a relative humidity of 50% RH; and the electrophotographic photosensitive member was evaluated based on the previously described memory evaluation method. The results are shown in Table 1.

### Comparative Example 5

An electrophotographic photosensitive member was produced in the same way as in Example 1 except that an undercoat layer, a charge generation layer and a charge transport layer in Example 2 described in Japanese Patent Application Laid-Open No. H11-184119 were produced on the support described in Example 1; with the use of the produced electrophotographic photosensitive member, Pₑ, α, η₀ and Vᵣ were measured by the previously described method, in an environment at a temperature of 23.5° C. and a relative humidity of 50% RH; and the electrophotographic photosensitive member was evaluated based on the previously described memory evaluation method. The results are shown in Table 1.

### Comparative Example 6

An electrophotographic photosensitive member was produced in the same way as in Example 1 except that an undercoat layer, a charge generation layer and a charge transport layer in Example 2 described in Japanese Patent Application Laid-Open No. H10-115939 were produced on the support described in Example 1; with the use of the produced electrophotographic photosensitive member, Pₑ, α, η₀ and Vᵣ were measured by the previously described method, in an environment at a temperature of 23.5° C. and a relative humidity of 50% RH; and the electrophotographic photosensitive member was evaluated based on the previously described memory evaluation method. The results are shown in Table 1.

### Comparative Example 7

An electrophotographic photosensitive member was produced in the same way as in Example 1 except that a charge generation layer and a charge transport layer in Example 3 described in Japanese Patent Application Laid-Open No. H05-080544 were produced on the support described in Example 1; with the use of the produced electrophotographic photosensitive member, Pₑ, α, η₀ and Vᵣ were measured by the previously described method, in an environment at a temperature of 23.5° C. and a relative humidity of 50% RH; and the electrophotographic photosensitive member was evaluated based on the previously described memory evaluation method. The results are shown in Table 1.

### Comparative Example 8

An electrophotographic photosensitive member was produced in the same way as in Example 1 except that an intermediate layer, a charge generation layer and a charge transport layer in Formula-1 described in Japanese Patent Application Laid-Open No. 2001-183852 were produced on the support described in Example 1; with the use of the produced electrophotographic photosensitive member, Pₑ, α, η₀ and Vᵣ were measured by the previously described method, in an environment at a temperature of 23.5° C. and a relative humidity of 50% RH; and the electrophotographic photosensitive member was evaluated based on the previously described memory evaluation method. The results are shown in Table 1.

TABLE 1

| | Pₑ slope α | | | Vᵣ | Initial | Memory after |
|---|---|---|---|---|---|---|
| | (×10⁻³) | Pₑ | η₀ | (ev) | memory | endurance |
| Example 1 | 1.2 | 0.6 | 0.5 | 12 | A | A |
| Example 2 | 2 | 0.56 | 0.5 | 15 | A | A |
| Example 3 | 3 | 0.65 | 0.5 | 15 | A | B |
| Example 4 | 3.5 | 0.8 | 0.5 | 20 | B | C |
| Example 5 | 1.2 | 0.75 | 0.5 | 12 | B | B |
| Example 6 | 2 | 0.65 | 0.5 | 12 | A | A |
| Example 7 | 1.2 | 0.72 | 0.5 | 12 | B | B |
| Example 8 | 2 | 0.68 | 0.35 | 12 | B | B |
| Example 9 | 2.2 | 0.62 | 0.3 | 12 | B | B |
| Example 10 | 1.2 | 0.65 | 0.4 | 18 | A | A |
| Example 11 | 1.2 | 0.68 | 0.5 | 12 | A | A |
| Example 12 | 1.3 | 0.73 | 0.5 | 12 | B | B |
| Example 13 | 1.3 | 0.82 | 0.5 | 10 | B | B |
| Example 14 | 1.4 | 0.58 | 0.5 | 18 | B | B |
| Example 15 | 1.5 | 0.72 | 0.4 | 21 | C | C |
| Example 16 | 1.2 | 0.58 | 0.5 | 12 | A | A |
| Example 17 | 1.6 | 0.58 | 0.5 | 12 | A | A |
| Example 18 | 1.6 | 0.68 | 0.5 | 12 | A | A |
| Example 19 | 1.8 | 0.67 | 0.5 | 12 | A | A |
| Example 20 | 2 | 0.75 | 0.5 | 12 | B | B |
| Example 21 | 4 | 0.8 | 0.35 | 12 | B | C |
| Example 22 | 1.2 | 0.6 | 0.5 | 8 | A | A |
| Example 23 | 1.2 | 0.6 | 0.5 | 10 | A | A |
| Example 24 | 1.2 | 0.6 | 0.5 | 15 | A | A |
| Example 25 | 1.2 | 0.6 | 0.5 | 20 | A | A |
| Example 26 | 1.2 | 0.6 | 0.5 | 25 | B | B |
| Example 27 | 1.2 | 0.6 | 0.5 | 40 | B | B |
| Example 28 | 1.4 | 0.6 | 0.4 | 30 | B | B |
| Comparative | 7.7 | 0.75 | 0.3 | 100 | B | D |
| Example 1 | | | | | | |
| Comparative | 6.2 | 0.65 | 0.4 | 80 | B | D |
| Example 2 | | | | | | |
| Comparative | 5 | 0.85 | 0.4 | 30 | B | E |
| Example 3 | | | | | | |
| Comparative | 5.8 | 0.75 | 0.2 | 40 | C | E |
| Example 4 | | | | | | |
| Comparative | 6.1 | 0.86 | 0.3 | 5 | B | E |
| Example 5 | | | | | | |
| Comparative | 7.2 | 0.87 | 0.2 | 50 | C | E |
| Example 6 | | | | | | |
| Comparative | 6.5 | 0.9 | 0.2 | 50 | C | E |
| Example 7 | | | | | | |
| Comparative | 5.3 | 0.82 | 0.2 | 30 | C | E |
| Example 8 | | | | | | |

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-130210, filed Aug. 6, 2021, which is hereby incorporated by reference herein in its entirety.

What is claimed is:

1. An electrophotographic photosensitive member comprising:
a support,
a charge generation layer on the support, and
a charge transport layer on the charge generation layer,
the charge generation layer having a film thickness of 0.2 μm or larger, wherein
in a case where, at a temperature of 23.5 [° C.] and a relative humidity of 50 [% RH], the electrophotographic photosensitive member is subjected to operations and measurement of:
(1) setting a surface potential of the electrophotographic photosensitive member to 0 [V];
(2) electrostatically charging the electrophotographic photosensitive member for 0.005 seconds so that an absolute value of the surface potential of the electrophotographic photosensitive member becomes Vd [V];
(3) 0.02 seconds after a start of electrostatic charging, exposing the electrostatically charged electrophotographic photosensitive member to light having a wave length of 805 [nm] and a light quantity of Iₑₓₚ [μJ/cm²]; and
(4) 0.06 seconds after the start of the electrostatic charging, measuring the absolute value of the surface potential of the electrophotographic photosensitive member after exposure, the absolute value being represented by Vₑₓₚ [V],
in a relationship between a recombination constant Pₑ and an electric field strength E, which is obtained from a graph in which a horizontal axis represents a light quantity Iₑₓₚ of exposure light and a vertical axis represents the absolute value Vₑₓₚ of the surface potential, which has been obtained by repeatedly performing the operations and the measurement of (1) to (4) while changing Iₑₓₚ from 0.000 to 1.000 [μJ/cm²] at intervals of 0.001 [μJ/cm²], an absolute value of a slope a of a linear approximation straight line is 4×10⁻³ or smaller, in a range where the electric field strength E expressed by the following Expression (1) is 10 to 40 V/μm:
Pₑ=α×E+γ (1),
where, in the Expression (1) and the following Expression (2), Pₑ and Vᵣ represent a recombination constant and a residual charge, respectively, which are obtained from the following Expression (2), where a quantum efficiency is represented by η₀, which is obtained with the use of the following Expression (3) from data points in the graph in a range until Vₑₓₚ of the graph decreases to Vd/2; and E represents the electric field strength V/μm obtained from the Vd and the film thickness of the charge transport layer:
$$\frac{{V}_{exp} - {V}_{r}}{{V}_{d} - {V}_{r}} = {[ 1 - ( 1 - {P}_{e} ) \frac{e d {η}_{0} {I}_{exp}}{{ε}_{0} {ε}_{r} h v ( {V}_{d} - {V}_{r} )} ]}^{1 / ( 1 - {p}_{e} )} \qquad ( 2 )$$
$$\frac{{V}_{exp}}{{v}_{d}} = {[ 1 - 0.4 \frac{e d {η}_{0} {I}_{exp}}{{ε}_{0} {ε}_{r} h v {V}_{d}} ]}^{2.5} , \qquad ( 3 )$$
where, in the Expressions (2) and (3), e represents an elementary charge, d represents a film thickness of the photosensitive layer, η₀ represents a quantum efficiency, ε₀ represents a dielectric constant of vacuum, εᵣ represents a relative dielectric constant, h represents a Planck constant, and v represents a frequency of irradiation light.

2. The electrophotographic photosensitive member according to claim 1, wherein the absolute value of the slope α of the linear approximation straight line is 2×10⁻³ or smaller.

3. The electrophotographic photosensitive member according to claim 1, wherein the recombination constant Pₑ obtained from the Expression (2) at the time when the electric field strength is 15 V/μm is 0.7 or smaller.

4. The electrophotographic photosensitive member according to claim 1, wherein the quantum efficiency η₀ obtained from the Expression (2) at the time when the electric field strength is 15 V/μm is 0.4 or larger.

5. The electrophotographic photosensitive member according to claim 1, wherein the residual charge Vᵣ is 20 V or smaller, the residual charge Vᵣ being obtained from the Expression (2) at the time when the electric field strength is 15 V/μm.

6. The electrophotographic photosensitive member according to claim 1, wherein
the charge generation layer comprises a hydroxygallium phthalocyanine pigment,
the hydroxygallium phthalocyanine pigment has peaks at 7.4°±0.3° and 28.2°±0.3°, respectively, in a spectrum (Bragg angle 2θ) of X-ray diffraction using a CuKα ray, and
A is 0.8 or less, the A being determined from an angle θ₁ [° ] and an integral width β₁ [° ] of the peak at 7.4°±0.3°, and an angle θ₂ [° ] and an integral width β₂ [° ] of the peak at 28.2°±0.3°, and according to the following Expression (4):
$$A = \frac{{β}_{1} cos {θ}_{1}}{{β}_{2} cos {θ}_{2}} . \qquad ( 4 )$$

7. The electrophotographic photosensitive member according to claim 1, wherein
the charge generation layer comprises a charge generation material in a content of 65 to 75% by mass based on the total mass of the charge generation layer.

8. The electrophotographic photosensitive member according to claim 1, wherein
the charge transport layer comprises a charge transport material, and
the charge transport material has an ionization potential of 5.2 to 5.4 eV.

9. The electrophotographic photosensitive member according to claim 1, wherein
the electrophotographic photosensitive member comprises an undercoat layer directly under the charge generation layer, and
the undercoat layer comprises a titanium oxide particle surface-treated with vinyl silane.

10. A process cartridge, integrally supporting:
an electrophotographic photosensitive member, and
at least one unit selected from the group consisting of a charging unit, a developing unit, a transfer unit and a cleaning unit; and
the process cartridge being detachably attachable to a main body of an electrophotographic apparatus, wherein
the electrophotographic photosensitive member comprises:
a support,
a charge generation layer on the support, and
a charge transport layer on the charge generation layer, and the charge generation layer has a film thickness of 0.2 μm or larger, wherein
in a case where, at a temperature of 23.5 [° C.] and a relative humidity of 50 [% RH], the electrophotographic photosensitive member is subjected to operations and measurement of:
(1) setting a surface potential of the electrophotographic photosensitive member to 0 [V];
(2) electrostatically charging the electrophotographic photosensitive member for 0.005 seconds so that an absolute value of the surface potential of the electrophotographic photosensitive member becomes Vd [V];
(3) 0.02 seconds after a start of electrostatic charging, exposing the electrostatically charged electrophotographic photosensitive member to light having a wave length of 805 [nm] and a light quantity of Iₑₓₚ [μJ/cm²]; and
(4) 0.06 seconds after the start of the electrostatic charging, measuring the absolute value of the surface potential of the electrophotographic photosensitive member after exposure, the absolute value being represented by Vₑₓₚ [V],
in a relationship between a recombination constant Pₑ and an electric field strength E, which is obtained from a graph in which a horizontal axis represents a light quantity Iₑₓₚ of exposure light and a vertical axis represents the absolute value Vₑₓₚ of the surface potential, which has been obtained by repeatedly performing the operations and the measurement of (1) to (4) while changing Iₑₓₚ from 0.000 to 1.000 [μJ/cm²] at intervals of 0.001 [μJ/cm²], an absolute value of a slope a of a linear approximation straight line is 4×10⁻³ or smaller, in a range where the electric field strength E expressed by the following Expression (1) is 10 to 40 V/μm:
Pₑ=α×E+γ (1)
where, in the Expression (1) and the following Expression (2), Pₑ and Vᵣ represent a recombination constant and a residual charge, respectively, which are obtained from the following Expression (2), where a quantum efficiency is represented by η₀, which is obtained with the use of the following Expression (3) from data points in the graph in a range until Vₑₓₚ of the graph decreases to Vd/2; and E represents the electric field strength V/μm obtained from the Vd and the film thickness of the charge transport layer:
$$\frac{{V}_{exp} - {V}_{r}}{{V}_{d} - {V}_{r}} = {[ 1 - ( 1 - {P}_{e} ) \frac{e d {η}_{0} {I}_{exp}}{{ε}_{0} {ε}_{r} h v ( {V}_{d} - {V}_{r} )} ]}^{1 / ( 1 - {P}_{e} )} \qquad ( 2 )$$
$$\frac{{V}_{exp}}{{V}_{d}} = {[ 1 - 0.4 \frac{e d {η}_{0} {I}_{exp}}{{ε}_{0} {ε}_{r} h v {V}_{d}} ]}^{2.5} \qquad ( 3 )$$
where, in the Expressions (2) and (3), e represents an elementary charge, d represents a film thickness of the photosensitive layer, η₀ represents a quantum efficiency, ε₀ represents a dielectric constant of vacuum, εᵣ represents a relative dielectric constant, h represents a Planck constant, and v represents a frequency of irradiation light.

11. An electrophotographic apparatus comprising:
an electrophotographic photosensitive member,
a charging unit,
an exposure unit,
a developing unit, and
a transfer unit, wherein the electrophotographic photosensitive member comprises:
a support,
a charge generation layer on the support, and
a charge transport layer on the charge generation layer, and the charge generation layer has a film thickness of 0.2 μm or larger, wherein
in a case where, at a temperature of 23.5 [° C.] and a relative humidity of 50 [% RH], the electrophotographic photosensitive member is subjected to operations and measurement of:
(1) setting a surface potential of the electrophotographic photosensitive member to 0 [V];
(2) electrostatically charging the electrophotographic photosensitive member for 0.005 seconds so that an absolute value of the surface potential of the electrophotographic photosensitive member becomes Vd [V];
(3) 0.02 seconds after a start of electrostatic charging, exposing the electrostatically charged electrophotographic photosensitive member to light having a wave length of 805 [nm] and a light quantity of Iₑₓₚ [P/cm²]; and
(4) 0.06 seconds after the start of the electrostatic charging, measuring the absolute value of the surface potential of the electrophotographic photosensitive member after exposure, the absolute value being represented by Vₑₓₚ [V],
in a relationship between a recombination constant Pₑ and an electric field strength E, which is obtained from a graph in which a horizontal axis represents a light quantity Iₑₓₚ of exposure light and a vertical axis represents the absolute value Vₑₓₚ of the surface potential, which has been obtained by repeatedly performing the operations and the measurement of (1) to (4) while changing Iₑₓₚ from 0.000 to 1.000 [μJ/cm²] at intervals of 0.001 [μJ/cm²], an absolute value of a slope α of a linear approximation straight line is 4×10⁻³ or smaller, in a range where the electric field strength E expressed by the following Expression (1) is 10 to 40 V/μm:
Pₑ=α×E+γ (1)
where, in the Expression (1) and the following Expression (2), Pₑ and Vᵣ represent a recombination constant and a residual charge, respectively, which are obtained from the following Expression (2), where a quantum efficiency is represented by η₀, which is obtained with the use of the following Expression (3) from data points in the graph in a range until Vₑₓₚ of the graph decreases to Vd/2; and E represents the electric field strength V/μm obtained from the Vd and the film thickness of the charge transport layer:
$$\frac{{V}_{exp} - {V}_{r}}{{V}_{d} - {V}_{r}} = {[ 1 - ( 1 - {P}_{e} ) \frac{e d {η}_{0} {I}_{exp}}{{ε}_{0} {ε}_{r} h v ( {V}_{d} - {V}_{r} )} ]}^{1 / ( 1 - {P}_{e} )} \qquad ( 2 )$$
$$\frac{{V}_{exp}}{{V}_{d}} = {[ 1 - 0.4 \frac{e d {η}_{0} {I}_{exp}}{{ε}_{0} {ε}_{r} h v {V}_{d}} ]}^{2.5} \qquad ( 3 )$$
where, in the Expressions (2) and (3), e represents an elementary charge, d represents a film thickness of the photosensitive layer, η₀ represents a quantum efficiency, ε₀ represents a dielectric constant of vacuum, εᵣ represents a relative dielectric constant, h represents a Planck constant, and v represents a frequency of irradiation light.
